(19) United States
(12) Patent Application Publication
(10) Pub. No.: US 2025/0285037 A1
(43) Pub. Date: Sep. 11, 2025

(54) CONNECTING TRAVEL DATA STRUCTURES WITH VEHICLE DATA STRUCTURES

(71) Applicant: Capital One Services, LLC, McLean, VA (US)

(72) Inventors: Matthew Louis NOWAK, Midlothian, VA (US); Mohamed SECK, Aubrey, TX (US)

(21) Appl. No.: 18/595,723

(22) Filed: Mar. 5, 2024

(51) Int. Cl. G06Q 10/02; G06F 3/04842; G06F 16/9535; G06Q 50/40; H04L 9/40

(52) U.S. Cl. CPC G06Q 10/02; G06F 3/04842; G06F 16/9535; G06Q 50/40; H04L 63/083

(57) ABSTRACT

In some implementations, a connecting system may receive, from a first data source, event information associated with a travel itinerary and may receive, from a second data source, an indication of at least one destination location. The connecting system may further receive a preference associated with a user. The connecting system may provide the event information, the indication of the at least one destination location, and the preference to a machine learning model in order to receive an indication of a preferred vehicle option. The connecting system may output a representation of the preferred vehicle option to a user device associated with the user. The connecting system may receive, from the user device and in response to outputting the representation, a confirmation of the preferred vehicle option. The connecting system may communicate with an application programming interface function, in response to the confirmation, to secure the preferred vehicle option.

### BACKGROUND

Securing a vehicle, whether a rental car, a taxi reservation, or a rideshare request, among other examples, generally consumes network overhead. For example, a user may instruct a user device to communicate with multiple application programming interface (API) functions in order to research which vehicle to secure. The user may further instruct the user device to communicate with an API function to secure a selected vehicle. All of these communications consume power and processing resources at the user device as well as increasing network overhead.

### SUMMARY

Some implementations described herein relate to a system for automatically connecting travel with vehicles. The system may include one or more memories and one or more processors communicatively coupled to the one or more memories. The one or more processors may be configured to receive, from a first data source, event information associated with a flight. The one or more processors may be configured to determine, using the event information, a list of possible vehicle options. The one or more processors may be configured to receive, from a second data source, an indication of at least one destination location. The one or more processors may be configured to filter, using the at least one destination location, the list of possible vehicle options to generate a filtered list of possible vehicle options. The one or more processors may be configured to receive a preference associated with a user. The one or more processors may be configured to provide the filtered list of possible vehicle options and the preference to a machine learning model in order to receive an indication of a preferred vehicle option. The one or more processors may be configured to output a representation of the preferred vehicle option to a user device associated with the user. The one or more processors may be configured to receive, from the user device and in response to outputting the representation, a confirmation of the preferred vehicle option. The one or more processors may be configured to communicate with an API function, in response to the confirmation, to secure the preferred vehicle option.

Some implementations described herein relate to a method of automatically connecting travel with vehicles. The method may include receiving, from a first data source and at a connecting system, event information associated with a travel itinerary. The method may include receiving, from a second data source and at the connecting system, an indication of at least one destination location. The method may include receiving, at the connecting system, a preference associated with a user. The method may include providing, by the connecting system, the event information, the indication of the at least one destination location, and the preference to a machine learning model in order to receive an indication of a preferred vehicle option. The method may include outputting, from the connecting system, a representation of the preferred vehicle option to a user device associated with the user. The method may include receiving, from the user device, at the connecting system, and in response to outputting the representation, a confirmation of the preferred vehicle option. The method may include communicating, by the connecting system, with an API function, in response to the confirmation, to secure the preferred vehicle option.

Some implementations described herein relate to a non-transitory computer-readable medium that stores a set of instructions for automatically connecting travel with vehicles. The set of instructions, when executed by one or more processors of a device, may cause the device to transmit, to a travel system, an authorization to access a calendar associated with a user of the device. The set of instructions, when executed by one or more processors of the device, may cause the device to transmit, to the travel system, a preference associated with the user of the device. The set of instructions, when executed by one or more processors of the device, may cause the device to transmit an instruction to book a travel itinerary. The set of instructions, when executed by one or more processors of the device, may cause the device to receive, from the travel system, an indication of a preferred vehicle option. The set of instructions, when executed by one or more processors of the device, may cause the device to output a representation of the preferred vehicle option to the user. The set of instructions, when executed by one or more processors of the device, may cause the device to receive, from the user, an interaction with the representation of the preferred vehicle option. The set of instructions, when executed by one or more processors of the device, may cause the device to transmit, to the travel system, a confirmation of the preferred vehicle option in response to the interaction.

### BRIEF DESCRIPTION OF THE DRAWINGS

FIGS. 1A-1G are diagrams of an example implementation relating to connecting travel data structures with vehicle data structures, in accordance with some embodiments of the present disclosure.

FIGS. 2A-2B are diagrams of example user interfaces, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to connecting travel data structures with vehicle data structures, in accordance with some embodiments of the present disclosure.

FIG. 6 is a flowchart of an example process relating to connecting travel data structures with vehicle data structures, in accordance with some embodiments of the present disclosure.

### DETAILED DESCRIPTION

The following detailed description of example implementations refers to the accompanying drawings. The same reference numbers in different drawings may identify the same or similar elements.

When a user reserves a plane ticket or otherwise schedules travel, the user may also have to secure a rental car, a taxi reservation, a rideshare request, or another type of vehicle. Therefore, the user may instruct a user device to communicate with multiple application programming interface (API) functions in order to research which vehicle to secure. For example, the user may compare availability, cost, and other factors. Furthermore, the user may instruct the user device to communicate with an API function to secure a selected vehicle. For example, the user may interact with user interfaces (UIs) on the user device in order to secure the selected vehicle (e.g., using a website associated with a provider of the selected vehicle). Therefore, the user device consumes power and processing resources in executing all of the user's instructions. Additionally, the user device's communications with multiple API functions increases network overhead.

Some implementations described herein enable use of a machine learning model (e.g., by a connecting system) to accept, as input, event information (e.g., associated with a travel itinerary and/or a calendar of a user) and provide, as output, vehicle information. As a result, network overhead is conserved that otherwise would have been spent on numerous communications with a user device. The user device may receive (e.g., from the connecting system) an indication of a preferred vehicle option, which conserves power and processing resources that otherwise would have been consumed in communicating with multiple API functions in order to research which vehicle to secure. Additionally, the connecting system may secure a selected vehicle, which further conserves power and processing resources at the user device that otherwise would have been consumed in securing the selected vehicle (e.g., using a website associated with a provider of the selected vehicle).

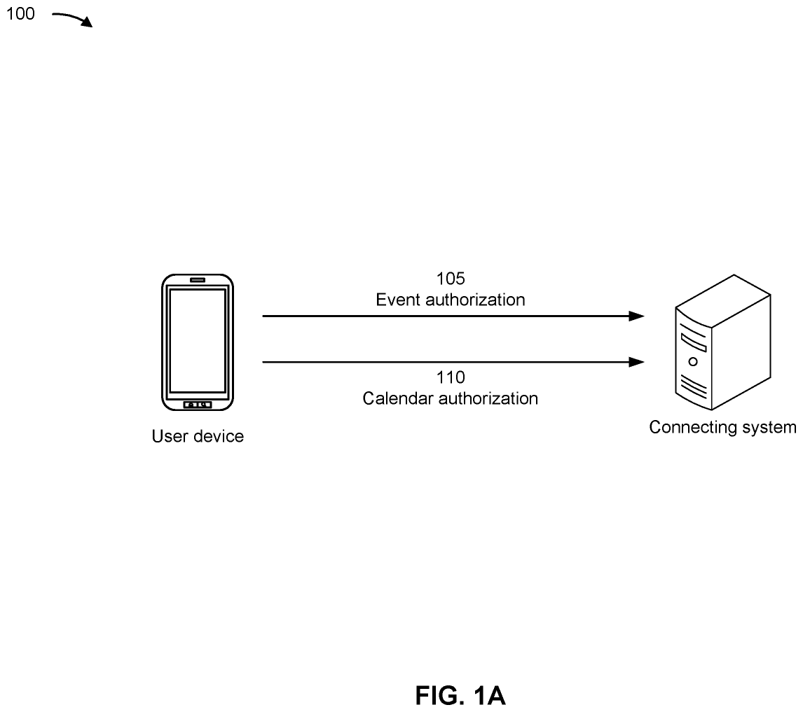

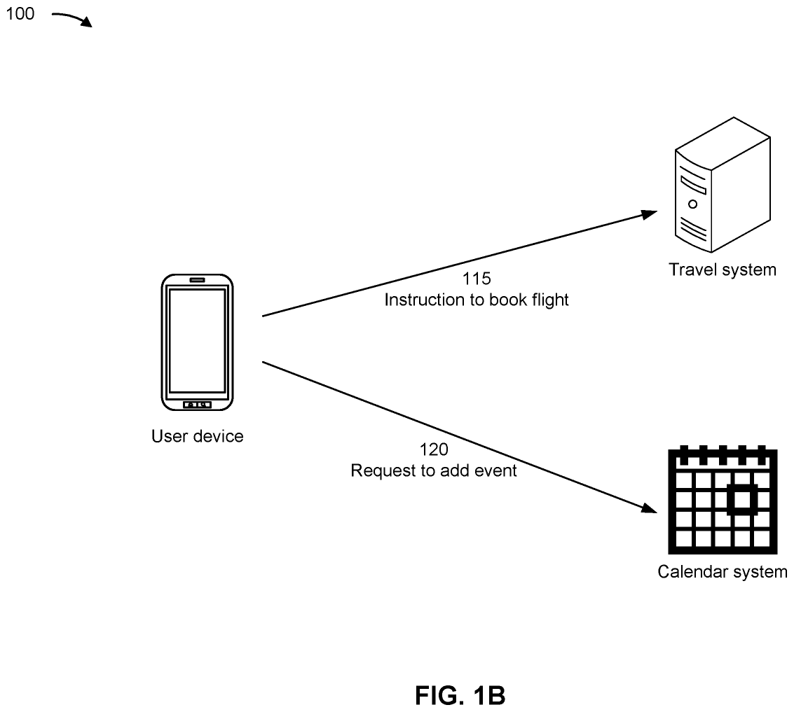

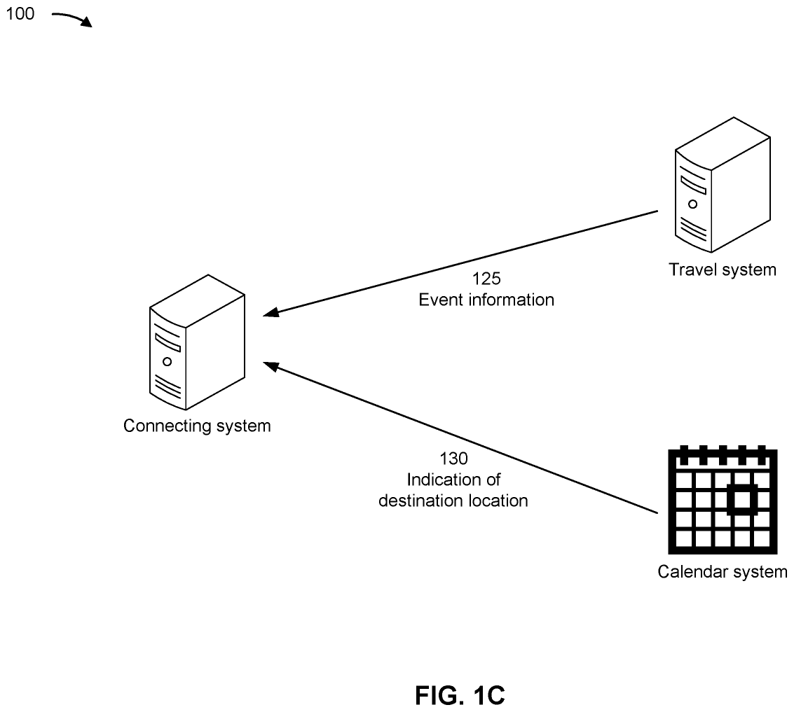

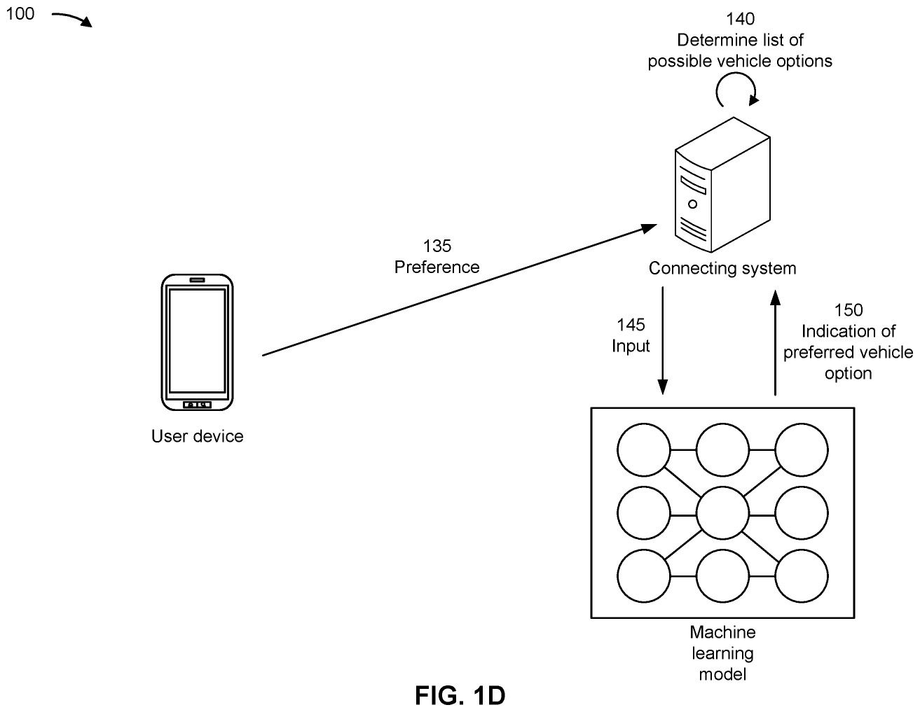

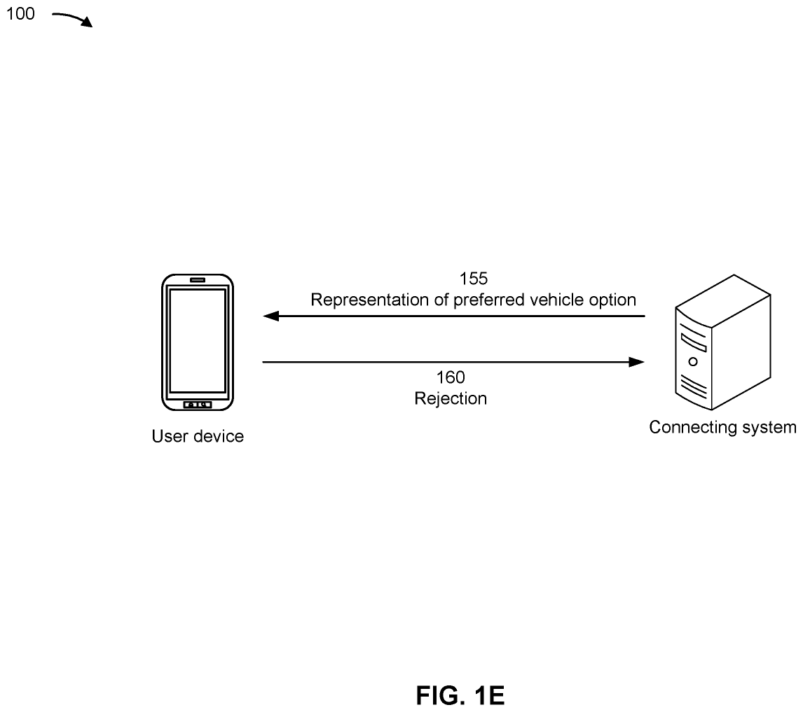

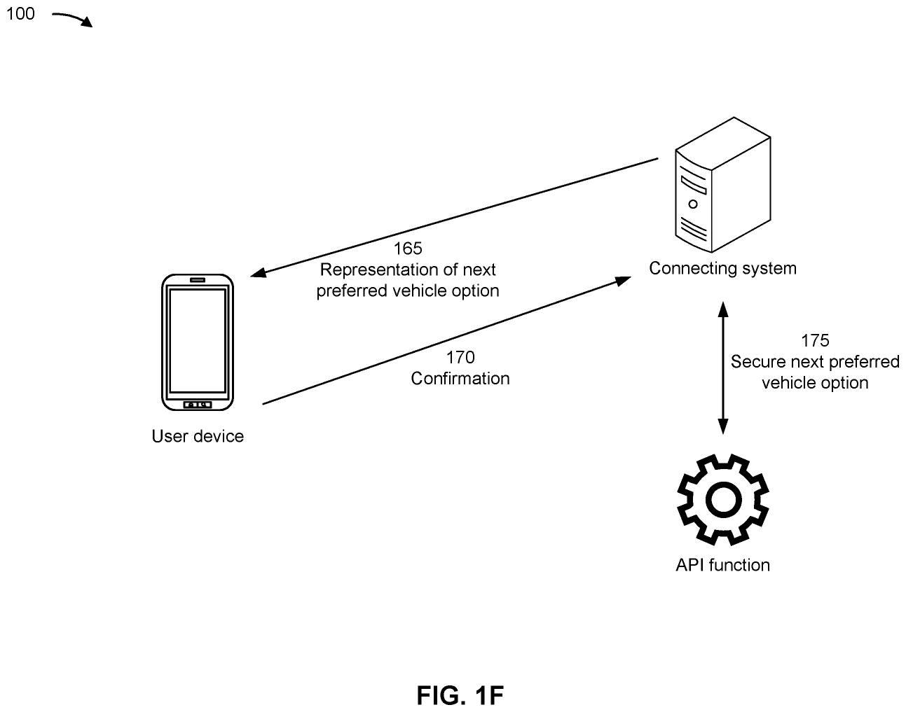

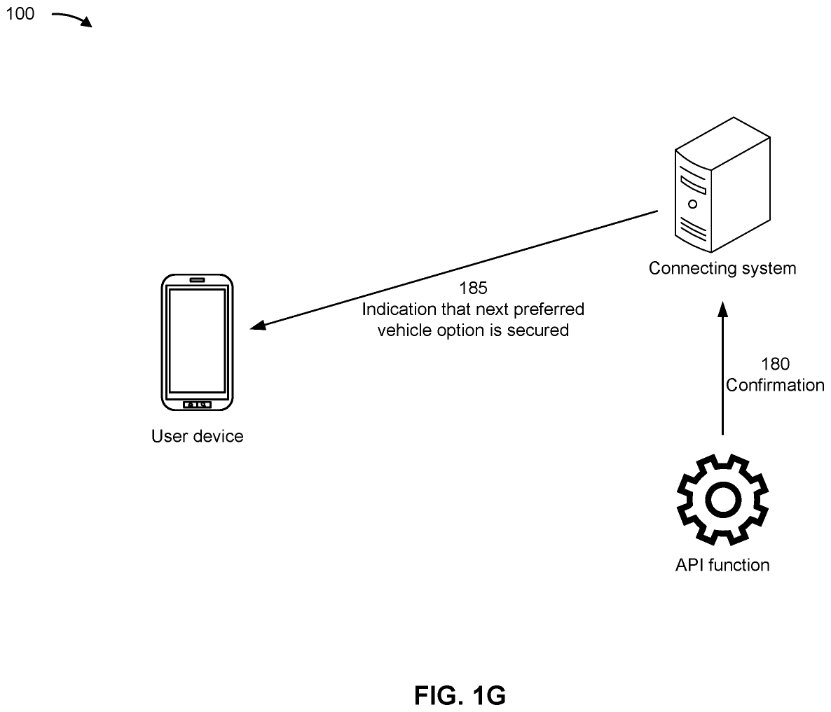

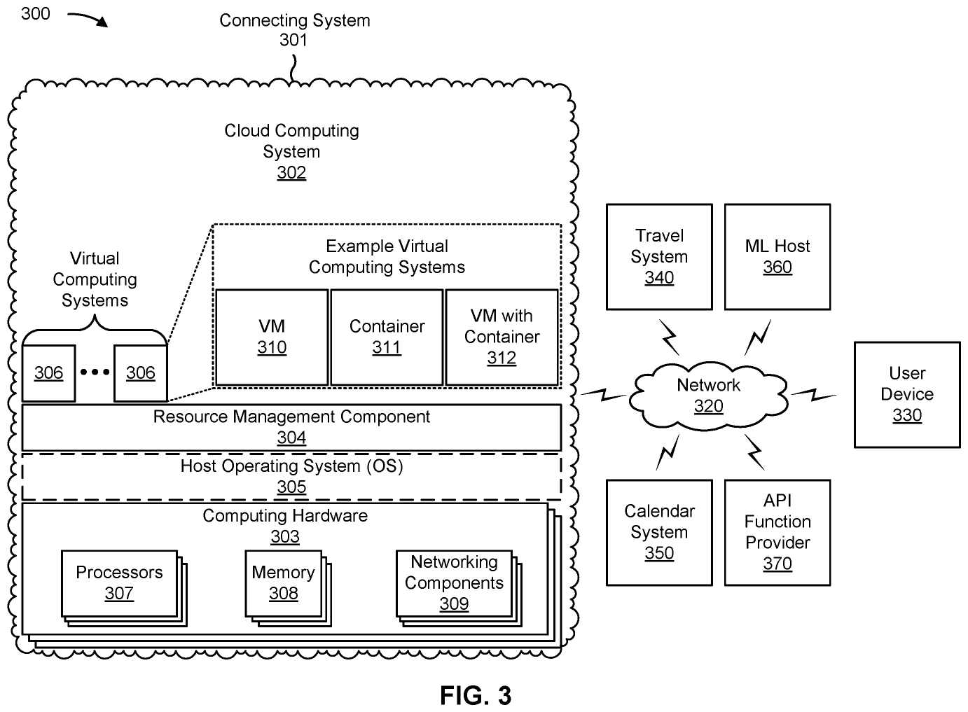

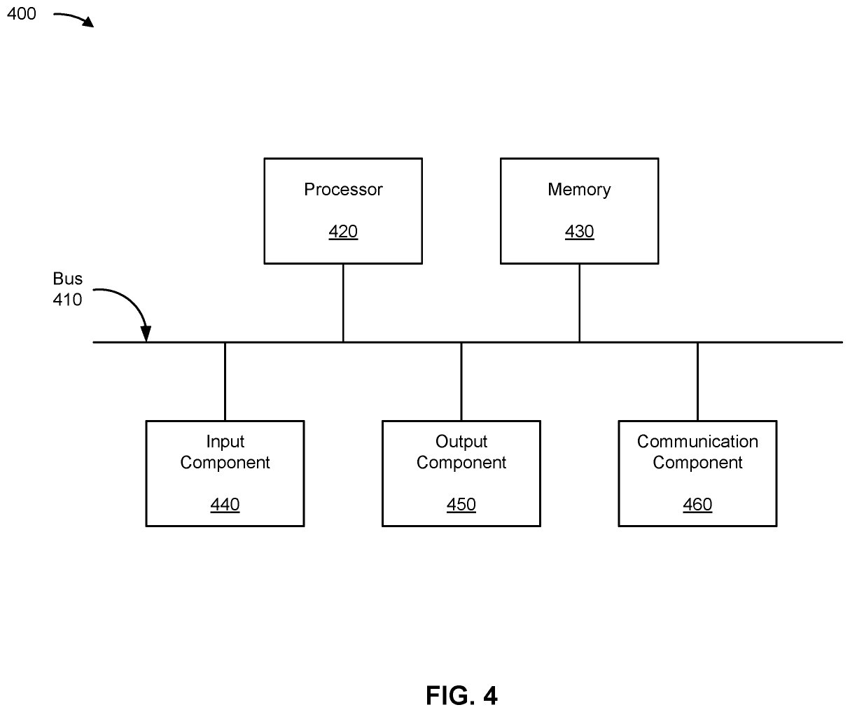

FIGS. 1A-1G are diagrams of an example 100 associated with connecting travel data structures with vehicle data structures. As shown in FIGS. 1A-1G, example 100 includes a user device, a connecting system, a travel system, a calendar system, a machine learning (ML) model (e.g., provided by an ML host), and an API function (e.g., hosted by an API function provider). These devices are described in more detail in connection with FIGS. 3 and 4.

As shown in FIG. 1A and by reference number 105, the user device may transmit, and the connecting system may receive, an authorization to access event information. The authorization may include a set of credentials (e.g., a username and password, a passcode, a private key, a certificate, and/or biometric information, among other examples). Additionally, or alternatively, the authorization may include a data structure that may be used to request the event information from a first data source. The first data source may include the travel system described in connection with the example 100. Additionally, or alternatively, the first data source may include a transaction system, and the event information may include transaction information.

In some implementations, a user of the user device may provide input (e.g., using an input component of the user device) that triggers the user device to transmit the authorization to access the event information. For example, the user device may output a UI to the user (e.g., via an output component of the user device), and the user may interact with the UI to provide the input that triggers the user device to transmit the authorization. In some implementations, a web browser (or another type of application executed by the user device) may navigate to a website controlled by (or at least associated with) the connecting system, and the web browser may output the UI to represent the website.

As shown by reference number 110, the user device may transmit, and the connecting system may receive, an authorization to access a calendar. The authorization may include a set of credentials (e.g., a username and password, a passcode, a private key, a certificate, and/or biometric information, among other examples). Additionally, or alternatively, the authorization may include a data structure that may be used to request calendar information from a second data source. The second data source may include the calendar system described in connection with the example 100.

In some implementations, the user of the user device may provide input (e.g., using an input component of the user device) that triggers the user device to transmit the authorization to access the calendar. For example, the user device may output a UI to the user (e.g., via an output component of the user device), and the user may interact with the UI to provide the input that triggers the user device to transmit the authorization. In some implementations, a web browser (or another type of application executed by the user device) may navigate to a website controlled by (or at least associated with) the connecting system, and the web browser may output the UI to represent the website.

As shown in FIG. 1B and by reference number 115, the user device may transmit, and the travel system may receive, an instruction to book a flight. The instruction may include a command to reserve the flight (e.g., identified by date, flight number, and/or another type of alphanumeric identifier). The travel system may be operated by an airline (e.g., associated with the flight) or operated by a third party (e.g., Capital One® Travel, among other examples). In some implementations, the user of the user device may provide input (e.g., using an input component of the user device) that triggers the user device to transmit the instruction to book the flight. For example, the user device may output a UI to the user (e.g., via an output component of the user device), and the user may interact with the UI to provide the input that triggers the user device to transmit the authorization. In some implementations, a web browser (or another type of application executed by the user device) may navigate to a website controlled by (or at least associated with) the travel system, and the web browser may output the UI to represent the website.

Although the example 100 is described in connection with a flight, other examples may include an instruction to book a travel itinerary. For example, the travel itinerary may include a train reservation, a ferry reservation, a bus reservation, a shuttle reservation, a private car reservation, or another type of reserved transportation mode. The command to reserve the travel itinerary may identify the travel itinerary by date, confirmation number, reservation number, and/or another type of alphanumeric identifier.

Additionally, as shown by reference number 120, the user device may transmit, and the calendar system may receive, a request to add an event. The request may include a command to add the event to a calendar data structure associated with the user. In some implementations, the user of the user device may provide input (e.g., using an input component of the user device) that triggers the user device to transmit the request to add the event. For example, the user device may output a UI to the user (e.g., via an output component of the user device), and the user may interact with the UI to provide the input that triggers the user device to transmit the authorization. In some implementations, a web browser (or another type of application executed by the user device) may navigate to a website controlled by (or at least associated with) the calendar system, and the web browser may output the UI to represent the website.

As shown in FIG. 1C and by reference number 125, the travel system may transmit, and the connecting system may receive, event information associated with the flight (e.g., reserved based on the instruction from the user device, as described in connection with reference number 115). The event information may be encoded in a data structure (e.g., a table, a comma separated values (CSV) file, or another type of data structure). The event information may include an indication of a departure airport (e.g., using an International Air Transport Association (IATA) airport code and/or another type of alphanumeric identifier), an indication of a destination airport (e.g., using an IATA airport code and/or another type of alphanumeric identifier), an indication of the flight (e.g., using a flight number and/or another type of alphanumeric identifier), an indication of a datetime of departure, and/or an indication of a datetime of arrival, among other examples. In implementations where the even information is associated with a travel itinerary, the event information may include an indication of a departure location (e.g., using an address or another type of identifier of a train station, a port, a bus station, or another type of location), an indication of a destination location (e.g., using an address or another type of identifier of a train station, a port, a bus station, or another type of location), an indication of the travel itinerary (e.g., using a confirmation number and/or another type of alphanumeric identifier), an indication of a datetime of departure, and/or an indication of a datetime of arrival, among other examples.

In some implementations, the connecting system may transmit, and the travel system may receive, a request for the event information. The request may include a hypertext transfer protocol (HTTP) request, a file transfer protocol (FTP) request, and/or an API call, among other examples. The request may include (e.g., in a header and/or as an argument) an indication of the user (e.g., a name and/or another type of identifier). The request may include the authorization described in connection with reference number 105. Accordingly, the travel system may transmit, and the connecting system may receive, a response (e.g., an HTTP response, an FTP response, and/or as a return from an API function) including the event information. Additionally with, or alternatively to, receiving the event information on demand (e.g., via a pull from the connecting system), the connecting system may receive the event information periodically and/or as available (e.g., via a push from the travel system). For example, the connecting system may subscribe to updates from the travel system such that the travel system transmits event information periodically (e.g., according to a schedule) and/or in real time (or at least near real time) (e.g., as new event information becomes available, such as in response to instructions from the user device, as described in connection with reference number 115).

Although the example 100 is described with the travel system transmitting the event information, other examples may include a transaction processor as a source for the event information. For example, the transaction processor may include one or more devices capable of processing, authorizing, and/or facilitating a transaction. For example, the transaction processor may include one or more servers and/or computing hardware (e.g., in a cloud computing environment or separate from a cloud computing environment) configured to receive and/or store information associated with processing an electronic transaction. The transaction processor may process a transaction, such as to approve (e.g., permit, authorize, or the like) or decline (e.g., reject, deny, or the like) the transaction and/or to complete the transaction if the transaction is approved. The transaction processor may be associated with a financial institution (e.g., a bank, a lender, a credit card company, or a credit union) and/or may be associated with a transaction card association that authorizes a transaction and/or facilitates a transfer of funds. For example, the transaction processor may be associated with an issuing bank, an acquiring bank (or merchant bank), and/or a transaction card association (e.g., VISA® or MASTERCARD®). Therefore, the event information may be associated with the transaction, and the transaction may be generated based on the instruction from the user device (e.g., in order to pay for the flight or other travel itinerary).

Although the example 100 is described with the travel system being separate from the connecting system, other examples may include the connecting system at least partially integrated (e.g., virtually, physically, and/or logically) with the travel system. Accordingly, the connecting system may receive the event information from storage (e.g., from a cache or another type of memory controlled by the connecting system) rather than from a separate system. Additionally, or alternatively, the connecting system may be at least partially integrated (e.g., virtually, physically, and/or logically) with the transaction processor described above. Accordingly, the connecting system may similarly receive the event information from storage (e.g., from a cache or another type of memory controlled by the connecting system) rather than from a separate system.

As shown by reference number 130, the calendar system may transmit, and the connecting system may receive, an indication of a destination location (e.g., at least one destination location). The destination location may be associated with the event (e.g., generated based on the request from the user device, as described in connection with reference number 120). The indication may include an address, coordinates (e.g., using a geographic coordinate system (GCS) or another type of coordinate system), or another type of location indicator. In some implementations, the flight may be associated with a departure date and a return date, and the event may be selected (e.g., by the calendar system) because the event is included in a date range (mathematically, an interval) bounded by the departure date and the return date (whether functioning as endpoints for an open interval, a closed interval, or a half-open interval).

In some implementations, the connecting system may transmit, and the calendar system may receive, a request for the destination location. The request may include an HTTP request, an FTP request, and/or an API call, among other examples. The request may include (e.g., in a header and/or as an argument) an indication of the date range (e.g., based on the event information from the travel system, such as the departure date and the return date of the flight). The request may include the authorization described in connection with reference number 110. Accordingly, the calendar system may transmit, and the connecting system may receive, a response (e.g., an HTTP response, an FTP response, and/or as a return from an API function) including the indication of the destination location. Additionally with, or alternatively to, receiving the indication of the destination location on demand (e.g., via a pull from the connecting system), the connecting system may receive the indication of the destination location periodically and/or as available (e.g., via a push from the travel system). For example, the connecting system may subscribe to updates from the calendar system such that the calendar system transmits indications of destination locations periodically (e.g., according to a schedule) and/or in real time (or at least near real time) (e.g., as new destination locations become available, such as in response to requests from the user device, as described in connection with reference number 120).

As shown in FIG. 1D and by reference number 135, the user device may transmit, and the connecting system may receive, a preference associated with the user. The preference may indicate whether the user prefers to drive or to ride, whether the user prefers price or convenience, a preferred car rental brand, a preferred rideshare mobile application (or “app”), and/or a preferred cab company, among other examples.

In some implementations, the connecting system may transmit, and the user device may receive, a request for the preference. The request may include an HTTP request, an FTP request, and/or an API call, among other examples. The request may include (e.g., in a header and/or as an argument) an indication of the user (e.g., a username and/or another type of alphanumeric identifier). Accordingly, the user device may transmit, and the connecting system may receive, a response (e.g., an HTTP response, an FTP response, and/or as a return from an API function) including the preference. Additionally, or alternatively, the connecting system may receive the preference from storage (e.g., from a cache or another type of memory controlled by the connecting system) rather than from the user device.

In some implementations, the user device and/or the connecting system may determine the preference based on historical information associated with the user. For example, the user device and/or the connecting system may receive the preference from an ML model (e.g., similarly as described below in connection with a preferred vehicle option). Therefore, the user device and/or the connecting system may store the preference (e.g., in a cache or another type of memory) for later retrieval.

As shown by reference number 140, the connecting system may determine a list of possible vehicle options. For example, the connecting system may filter a larger set of vehicle options into a small subset (where the smaller subset forms the list of possible vehicle options). The connecting system may use the event information to determine the list of possible vehicle options. In one example, the connecting system may map a location associated with the flight or other travel itinerary (e.g., a destination airport, train station, port, or bus station, among other examples, indicated in the event information) to the list of possible vehicle options. The connecting system may use a data structure that associates airport locations (and/or other types of locations) with lists of possible vehicle options.

In some implementations, the connecting system may further filter the list of possible vehicle options to generate a filtered list of possible vehicle options. For example, the connecting system may filter the list of possible vehicle options using the destination location. The connecting system may verify whether each possible vehicle option, included in the list, may be used for the destination location. Therefore, the connecting system may remove a possible vehicle option (e.g., at least one possible vehicle option) from the list, based on the possible vehicle option being unavailable for the destination location. For example, the connecting system may remove a public transportation option from the list based on the destination location being unavailable via public transportation. In another example, the connecting system may remove a rental car option from the list based on the destination location being outside a range associated with the rental car option.

As shown by reference number 145, the connecting system may provide input to the ML model. For example, the connecting system may transmit, and the ML host may receive, a request including the input. The input may include the filtered list of possible vehicle options and the preference. In other words, the ML model may assist with selecting from the filtered list. Additionally, or alternatively, the input may include the event information, the indication of the destination location, and the preference. Therefore, the connecting system may refrain from determining the list and/or filtering the list, and the ML model may generate vehicle options independently of any prior list and/or filter.

The ML model may be trained (e.g., by the ML host and/or a device at least partially separate from the ML host) using a labeled set of vehicle options (e.g., for supervised learning). Additionally, or alternatively, the ML model may be trained using an unlabeled set of vehicle options (e.g., for deep learning). The ML model may be configured to select a preferred vehicle option from the filtered list (or from the list, in implementation where the connecting system refrains from filtering the list). Additionally, or alternatively, the ML model may be configured to select a preferred vehicle option based on the event information, the indication of the destination location, and the preference. For example, the ML model may compare vectorized representations of vehicle options with a vectorized representation of the event information, the destination location, and the preference in order to select a vehicle option that has a vectorized representation closest to the vectorized representation of the event information, the destination location, and the preference. Additionally, or alternatively, the ML model may be configured to generate clusters representing groups of vehicle option in order to select a vehicle option from a cluster that most closely corresponds to the event information, the destination location, and the preference.

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the connecting system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 150, the routing system may receive an indication of the preferred vehicle option from the ML model (e.g., from the ML host). The indication may be an index and/or another type of alphanumeric indication of the preferred vehicle option. For example, each vehicle option in the (filtered) list of vehicle options may be associated with an identifier, and the ML model may indicate the identifier associated with the preferred vehicle option.

By applying the ML model to determine the preferred vehicle option, the connecting system conserves power and processing resources at the user device. In particular, the connecting system applies the ML model such that the user device refrains from communicating with multiple API functions in order to research vehicle options.

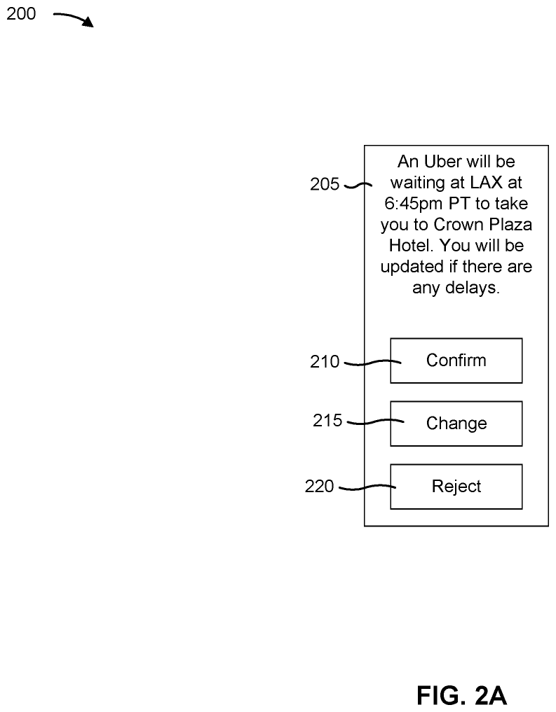

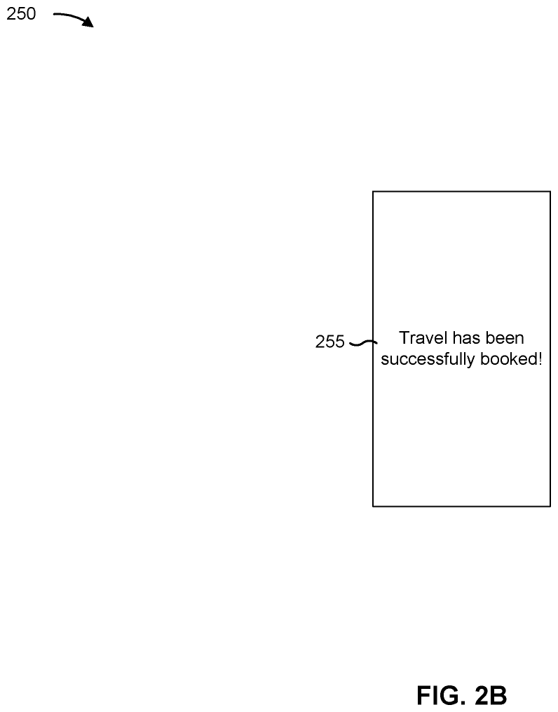

As shown in FIG. 1E and by reference number 155, the connecting system may output a representation of the preferred vehicle option to the user device. In some implementations, the representation may include a UI (e.g., as described in connection with FIG. 2A). Accordingly, the connecting system may transmit, and the user device may receive, instructions for the UI. The user device may output the representation of the preferred vehicle option to the user (e.g., using an output component of the user device).

The user may interact with the representation of the preferred vehicle option in order to accept the preferred vehicle option. Accordingly, as described below in connection with reference number 170, the user device may transmit, and the connecting system may receive, a confirmation of the preferred vehicle option in response to the interaction. Additionally, as described below in connection with reference number 175, the connecting system may communicate with an API function, in response to the confirmation, to secure the preferred vehicle option.

Alternatively, as shown by reference number 160, the user device may transmit, and the connecting system may receive, a rejection of the preferred vehicle option. For example, the user may interact with the representation of the preferred vehicle option in order to reject the preferred vehicle option. Therefore, the user device may transmit the rejection in response to the interaction. The rejection may be an indication of interaction with an interactive element of a UI (e.g., an interactive element associated with rejection).

As shown in FIG. 1F and by reference number 165, the connecting system may output a representation of a next preferred vehicle option to the user device. For example, the ML model may rank (or otherwise indicate an ordered list of) vehicle options. Accordingly, the connecting system may proceed to the next preferred vehicle option in response to the rejection from the user device.

In some implementations, the representation may include a UI (e.g., as described in connection with FIG. 2A). Accordingly, the connecting system may transmit, and the user device may receive, instructions for the UI. The user device may output the representation of the next preferred vehicle option to the user (e.g., using an output component of the user device).

The user may interact with the representation of the next preferred vehicle option in order to accept the next preferred vehicle option. Accordingly, as shown by reference number 170, the user device may transmit, and the connecting system may receive, a confirmation of the next preferred vehicle option. The user device may transmit the confirmation in response to the interaction. Therefore, the confirmation may be an indication of interaction with an interactive element of a UI (e.g., an interactive element associated with acceptance).

As shown by reference number 175, the connecting system may communicate with an API function in order to secure the next preferred vehicle option. For example, the connecting system may transmit a request to the API function that includes reservation information as an argument. The reservation information may include a datetime (e.g., based on the event information), an indication of a pickup location and an indication of a drop-off location (e.g., based on the event information and/or the destination location), and/or information about the user (e.g., a rewards account identifier, a name, a license identifier, and/or insurance information, among other examples). In some implementations, the request may further include a set of credentials associated with a service providing the preferred vehicle option. The set of credentials may include a username and password, a passcode, a private key, a certificate, and/or biometric information, among other examples. Accordingly, the set of credentials are used in communicating with the API function. The user device may transmit, and the connecting system may receive, the set of credentials. For example, the user of the user device may provide input (e.g., using an input component of the user device) that triggers the user device to transmit the set of credentials. Therefore, the user may authorize the connecting system to secure vehicles on the user's behalf.

By communicating with the API function to secure the next preferred vehicle option, the connecting system conserves power and processing resources at the user device. In particular, the connecting system communicates with the API function such that the user device refrains from securing the next preferred vehicle option (e.g., using a website associated with a provider of the next preferred vehicle option).

As shown in FIG. 1G and by reference number 180, the API function may transmit, and the connecting system may receive, a confirmation that the next preferred vehicle option is secured. For example, the API function may return the confirmation in response to a call from the connecting system to the API function. As shown by reference number 185, the connecting system may transmit, and the user device may receive, an indication that the next preferred vehicle option is secured. In some implementations, the indication may include a UI (e.g., as described in connection with FIG. 2B). Accordingly, the connecting system may transmit, and the user device may receive, instructions for the UI. The user device may output a representation that the next preferred vehicle option is secured to the user (e.g., using an output component of the user device).

In some implementations, the next preferred vehicle option may be unavailable. Accordingly, the API function may transmit, and the connecting system may receive, an error message (e.g., in response to a call from the connecting system to the API function). The connecting system may thus output an indication of the error message to the user device. Additionally, the connecting system may output an indication of a subsequent preferred vehicle option that was indicated by the ML model (e.g., as described above in connection with reference number 165). Therefore, the user may accept the subsequent preferred vehicle option (e.g., as described above), and the connecting system may communicate with an additional API function (e.g., associated with a provider of the subsequent preferred vehicle option) in order to secure the subsequent preferred vehicle option.

By using techniques as described in connection with FIGS. 1A-1G, the ML model conserves network overhead that otherwise would have been spent on numerous communications (e.g., in researching which vehicle option to secure). Additionally, the user device receives (e.g., from the connecting system) an indication of a preferred vehicle option, which conserves power and processing resources that otherwise would have been consumed in communicating with multiple API functions (e.g., in researching which vehicle option to secure). Additionally, the connecting system communicates with the API function to secure the (next) preferred vehicle option, which conserves power and processing resources at the user device that otherwise would have been consumed in securing the (next) preferred vehicle option (e.g., using a website).

As indicated above, FIGS. 1A-1G are provided as an example. Other examples may differ from what is described with regard to FIGS. 1A-1G.

FIGS. 2A and 2B are diagrams of an example UI 200 and an example UI 250, respectively, associated with connecting travel data structures with vehicle data structures. The example UIs 200 and/or 250 may be shown by a user device (e.g., based on instructions from a connecting system). These devices are described in more detail in connection with FIGS. 3 and 4.

As shown in FIG. 2A, the example UI 200 may include an indication 205 of a preferred vehicle option (e.g., determined as described in connection with FIG. 1D). The user device may output the example UI 200 in response to an indication, from the connecting system, of the preferred vehicle option. Additionally, the example UI 200 may include a first interactive element 210 (e.g., a first button). The first interactive element 210 may trigger the user device to transmit a confirmation of the preferred vehicle option. The example UI 200 may further include a second interactive element 215 (e.g., a second button). The second interactive element 215 may trigger the user device to transmit a requested change to the preferred vehicle option. For example, the requested change may include a different datetime (e.g., for pickup by a rideshare, for pickup of a rental vehicle, and/or for drop-off of a rental vehicle, among other examples), an indication of a different pickup location, an indication of a different drop-off location, and/or updated information about the user (e.g., a name change and/or an addition of a second driver or a passenger, among other examples). Additionally, the example UI 200 may include a third interactive element 220 (e.g., a third button). The third interactive element 220 may trigger the user device to transmit a rejection of the preferred vehicle option.

As shown in FIG. 2B, the example UI 250 may include an indication 255 that a preferred vehicle option (e.g., as previously indicated using the example UI 200) is secured. Accordingly, the user device may output the example UI 250 in response to an indication, from the connecting system, that the preferred vehicle option is secured.

As indicated above, FIGS. 2A-2B are provided as examples. Other examples may differ from what is described with regard to FIGS. 2A-2B. For example, the second interactive element 215 or the third interactive element 220 may be omitted from the example UI 200.

FIG. 3 is a diagram of an example environment 300 in which systems and/or methods described herein may be implemented. As shown in FIG. 3, environment 300 may include a connecting system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, a travel system 340, a calendar system 350, an ML host 360, and/or an API function provider 370. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-

based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the connecting system 301 may include one or more elements 303-312 of the cloud computing system 302, may execute within the cloud computing system 302, and/or may be hosted within the cloud computing system 302, in some implementations, the connecting system 301 may not be cloud-based (e.g., may be implemented outside of a cloud computing system) or may be partially cloud-based. For example, the connecting system 301 may include one or more devices that are not part of the cloud computing system 302, such as device 400 of FIG. 4, which may include a standalone server or another type of computing device. The connecting system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with vehicle preferences, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The travel system 340 may include one or more devices capable of receiving, generating, storing, processing, and/or providing information associated with travel itineraries, as described elsewhere herein. The travel system 340 may include a communication device and/or a computing device. For example, the travel system 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The travel system 340 may communicate with one or more other devices of environment 300, as described elsewhere herein.

The calendar system 350 may include one or more devices capable of receiving, generating, storing, processing, and/or providing information associated with calendar events, as described elsewhere herein. The calendar system 350 may include a communication device and/or a computing device. For example, the calendar system 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The calendar system 350 may communicate with one or more other devices of environment 300, as described elsewhere herein.

The ML host 360 may include one or more devices capable of receiving, generating, storing, processing, and/or providing information associated with machine learning models, as described elsewhere herein. The ML host 360 may include a communication device and/or a computing device. For example, the ML host 360 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 360 may communicate with one or more other devices of environment 300, as described elsewhere herein.

The API function provider 370 may include one or more devices capable of providing endpoints for API functions, as described elsewhere herein. The API function provider 370 may include a communication device and/or a computing device. For example, the API function provider 370 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The API function provider 370 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with connecting travel data structures with vehicle data structures. The device 400 may correspond to a user device 330, a travel system 340, a calendar system 350, an ML host 360, and/or an API function provider 370. In some implementations, a user device 330, a travel system 340, a calendar system 350, an ML host 360, and/or an API function provider 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

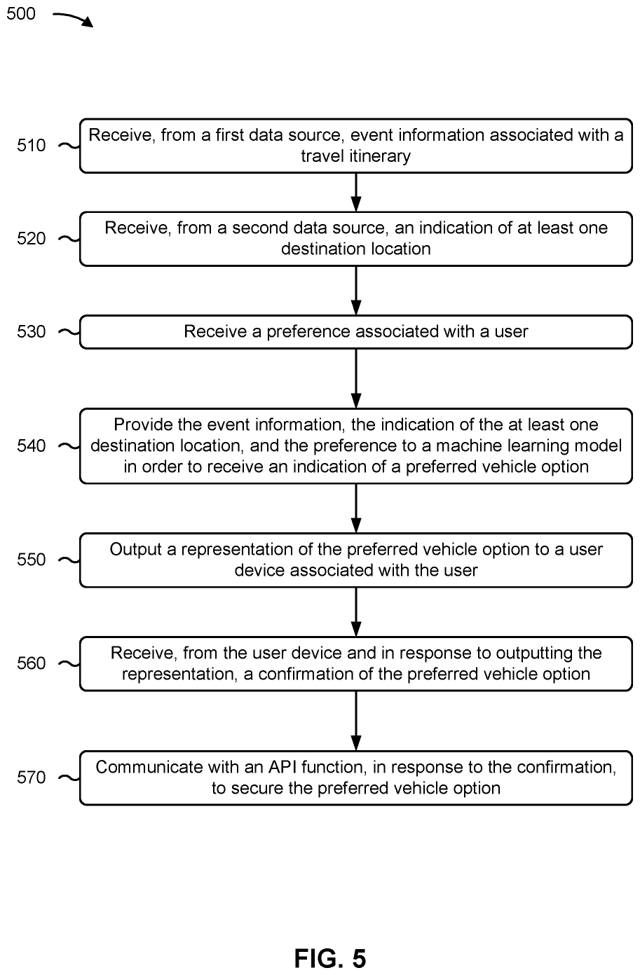

FIG. 5 is a flowchart of an example process 500 associated with connecting travel data structures with vehicle data structures. In some implementations, one or more process blocks of FIG. 5 may be performed by a connecting system 301. In some implementations, one or more process blocks of FIG. 5 may be performed by another device or a group of devices separate from or including the connecting system 301, such as a user device 330, a travel system 340, a calendar system 350, an ML host 360, and/or an API function provider 370. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a first data source, event information associated with a travel itinerary (block 510). For example, the connecting system 301 (e.g., using processor 420, memory 430, input component 440, and/or communication component 460) may receive, from a first data source, event information associated with a travel itinerary, as described above in connection with reference number 125 of FIG. 1C. As an example, the connecting system 301 may transmit, and the first data source may receive, a request for the event information. Accordingly, the first data source may transmit, and the connecting system 301 may receive, a response (e.g., an HTTP response, an FTP response, and/or as a return from an API function) including the event information.

As further shown in FIG. 5, process 500 may include receiving, from a second data source, an indication of at least one destination location (block 520). For example, the connecting system 301 (e.g., using processor 420, memory 430, input component 440, and/or communication component 460) may receive, from a second data source, an indication of at least one destination location, as described above in connection with reference number 130 of FIG. 1C. As an example, the connecting system 301 may transmit, and the second data source may receive, a request for the at least one destination location. Accordingly, the second data source may transmit, and the connecting system 301 may receive, a response (e.g., an HTTP response, an FTP response, and/or as a return from an API function) including the indication of the at least one destination location.

As further shown in FIG. 5, process 500 may include receiving a preference associated with a user (block 530). For example, the connecting system 301 (e.g., using processor 420, memory 430, input component 440, and/or communication component 460) may receive a preference associated with a user, as described above in connection with reference number 135 of FIG. 1D. As an example, the connecting system 301 may transmit, and a user device may receive, a request for the preference. Accordingly, the user device may transmit, and the connecting system 301 may receive, a response (e.g., an HTTP response, an FTP response, and/or as a return from an API function) including the preference. Additionally, or alternatively, the connecting system 301 may receive the preference from storage (e.g., from a cache or another type of memory controlled by the connecting system 301).

As further shown in FIG. 5, process 500 may include providing the event information, the indication of the at least one destination location, and the preference to a machine learning model in order to receive an indication of a preferred vehicle option (block 540). For example, the connecting system 301 (e.g., using processor 420, memory 430, and/or communication component 460) may provide the event information, the indication of the at least one destination location, and the preference to a machine learning model in order to receive an indication of a preferred vehicle option, as described above in connection with reference numbers 145 and 150 of FIG. 1D. As an example, the connecting system 301 may transmit, and an ML host may receive, a request including the event information, the indication of the at least one destination location, and the preference. The ML host may transmit, and the connecting system 301 may receive, the indication of the preferred vehicle option in response to the request. The ML model may be trained (e.g., by the ML host and/or a device at least partially separate from the ML host) using a labeled set of vehicle options (e.g., for supervised learning). Additionally, or alternatively, the ML model may be trained using an unlabeled set of vehicle options (e.g., for deep learning). The ML model may be configured to select the preferred vehicle option based on the event information, the indication of the destination location, and the preference.

As further shown in FIG. 5, process 500 may include outputting a representation of the preferred vehicle option to a user device associated with the user (block 550). For example, the connecting system 301 (e.g., using processor 420, memory 430, and/or communication component 460) may output a representation of the preferred vehicle option to a user device associated with the user, as described above in connection with reference number 155 of FIG. 1E. As an example, the representation may include a UI (e.g., as described in connection with FIG. 2A). Accordingly, the connecting system 301 may transmit, and the user device may receive, instructions for the UI.

As further shown in FIG. 5, process 500 may include receiving, from the user device and in response to outputting the representation, a confirmation of the preferred vehicle option (block 560). For example, the connecting system 301 (e.g., using processor 420, memory 430, and/or communication component 460) may receive, from the user device and in response to outputting the representation, a confirmation of the preferred vehicle option, as described above in connection with reference number 170 of FIG. 1F. As an example, the confirmation may be an indication of interaction with an interactive element of a UI (e.g., an interactive element associated with acceptance).

As further shown in FIG. 5, process 500 may include communicating with an API function, in response to the confirmation, to secure the preferred vehicle option (block 570). For example, the connecting system 301 (e.g., using processor 420, memory 430, and/or communication component 460) may communicate with an API function, in response to the confirmation, to secure the preferred vehicle option, as described above in connection with reference number 175 of FIG. 1F. As an example, the connecting system 301 may transmit a request to the API function that includes reservation information as an argument.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1G and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

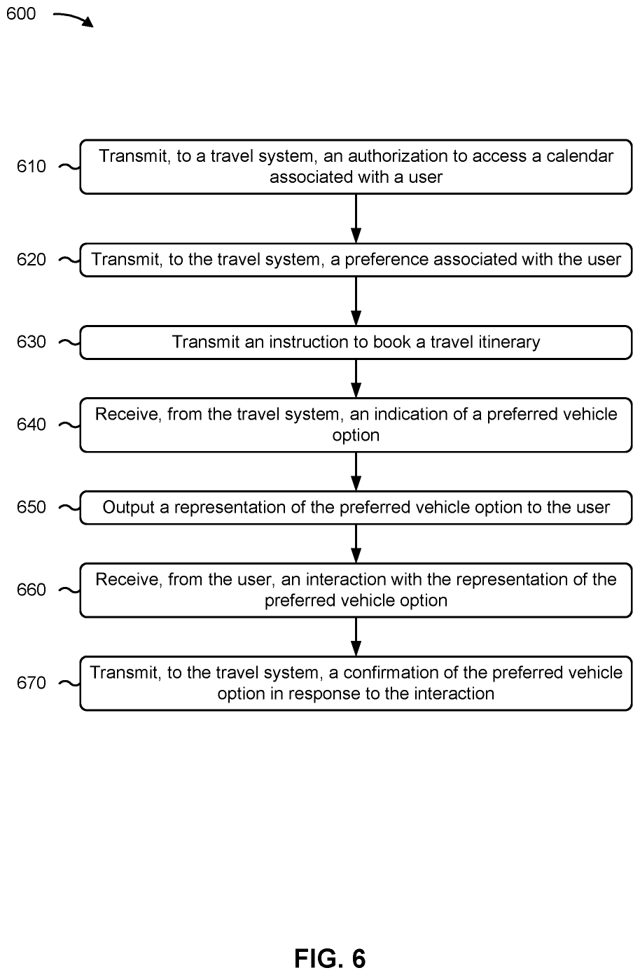

FIG. 6 is a flowchart of an example process 600 associated with connecting travel data structures with vehicle data structures. In some implementations, one or more process blocks of FIG. 6 may be performed by a user device 330. In some implementations, one or more process blocks of FIG. 6 may be performed by another device or a group of devices separate from or including the user device 330, such as a connecting system 301, a travel system 340, a calendar system 350, an ML host 360, and/or an API function provider 370. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a travel system, an authorization to access a calendar associated with a user (block 610). For example, the user device 330 (e.g., using processor 420, memory 430, and/or communication component 460) may transmit, to a travel system, an authorization to access a calendar associated with a user, as described above in connection with reference number 110 of FIG. 1A. As an example, authorization may include a set of credentials (e.g., a username and password, a passcode, a private key, a certificate, and/or biometric information, among other examples). Additionally, or alternatively, the authorization may include a data structure that may be used to request calendar information from a second data source.

As further shown in FIG. 6, process 600 may include transmitting, to the travel system, a preference associated with the user (block 620). For example, the user device 330 (e.g., using processor 420, memory 430, and/or communication component 460) may transmit, to the travel system, a preference associated with the user, as described above in connection with reference number 135 of FIG. 1D. As an example, the travel system may transmit, and the user device 330 may receive, a request for the preference. Accordingly, the user device 330 may transmit, and the travel system may receive, a response (e.g., an HTTP response, an FTP response, and/or as a return from an API function) including the preference.

As further shown in FIG. 6, process 600 may include transmitting an instruction to book a travel itinerary (block 630). For example, the user device 330 (e.g., using processor 420, memory 430, and/or communication component 460) may transmit an instruction to book a travel itinerary, as described above in connection with reference number 115 of FIG. 1B. As an example, the user of the user device 330 may provide input (e.g., using an input component of the user device 330) that triggers the user device 330 to transmit the instruction to book the travel itinerary. The user device 330 may transmit the instruction to the travel system, and the travel system may be operated by an operator (e.g., associated with the travel itinerary) or operated by a third party (e.g., Capital One Travel, among other examples).

As further shown in FIG. 6, process 600 may include receiving, from the travel system, an indication of a preferred vehicle option (block 640). For example, the user device 330 (e.g., using processor 420, memory 430, and/or communication component 460) may receive, from the travel system, an indication of a preferred vehicle option, as described above in connection with reference number 155 of FIG. 1E. As an example, the indication may include instructions for a UI.

As further shown in FIG. 6, process 600 may include outputting a representation of the preferred vehicle option to the user (block 650). For example, the user device 330 (e.g., using processor 420, memory 430, and/or output component 450) may output a representation of the preferred vehicle option to the user, as described above in connection with FIG. 1E. As an example, the representation may include a UI (e.g., as described in connection with FIG. 2A).

As further shown in FIG. 6, process 600 may include receiving, from the user, an interaction with the representation of the preferred vehicle option (block 660). For example, the user device 330 (e.g., using processor 420, memory 430, and/or input component 440) may receive, from the user, an interaction with the representation of the preferred vehicle option, as described above in connection with FIG. 1E. As an example, the interaction may include a click, a tap, a double-click, a keyboard entry, and/or an audio command.

As further shown in FIG. 6, process 600 may include transmitting, to the travel system, a confirmation of the preferred vehicle option in response to the interaction (block 670). For example, the user device 330 (e.g., using processor 420, memory 430, and/or communication component 460) may transmit, to the travel system, a confirmation of the preferred vehicle option in response to the interaction, as described above in connection with reference number 170 of FIG. 1F. As an example, the confirmation may be an indication of the interaction.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1G and/or FIGS. 2A-2B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for automatically connecting travel with vehicles, the system comprising:
one or more memories; and
one or more processors, communicatively coupled to the one or more memories, configured to:
receive, from a first data source, event information associated with a flight;
transmit an authorization to access a second data source;
determine, using the event information, a list of possible vehicle options;
receive, from the second data source, an indication of at least one destination location based on a subscription to updates from the second data source,
wherein the indication of at least one destination is received based on at least one of a schedule or updates to the second data source with new destination locations;
filter, using the at least one destination location, the list of possible vehicle options to generate a filtered list of possible vehicle options;
receive a preference associated with a user;
provide the filtered list of possible vehicle options and the preference to a machine learning model in order to receive an indication of a preferred vehicle option,
wherein a model parameter is used with the machine learning model,
wherein the model parameter includes an attribute of a model, associated with the machine learning model, that is learned from data input into the model,
wherein one or more hyperparameter sets are used to tune the machine learning model,
wherein the one or more hyperparameter sets include a structural parameter that controls execution of a machine learning algorithm, and
wherein the one or more hyperparameter sets are not learned from data input into the model;
output a representation of the preferred vehicle option to a user device associated with the user;
receive, from the user device and in response to outputting the representation, a confirmation of the preferred vehicle option;
communicate with an application programming interface (API) function, by transmitting a request to the API function, wherein the request is in response to the confirmation and includes information related to the preferred vehicle option, to secure the preferred vehicle option;
communicate with an additional API function, in response to an error message from communicating with the API function to secure the preferred vehicle option;
secure a subsequent preferred vehicle option that is indicated by the machine learning model based on transmitting another request to the additional API function, wherein the another request includes information related to the subsequent preferred vehicle option; and
transmitting instructions to the user device to generate user interface elements representing that the subsequent preferred vehicle option is secured.

2. The system of claim 1, wherein the one or more processors, to determine the list of possible vehicle options, are configured to:
map a location associated with the flight to the list of possible vehicle options.

3. The system of claim 1, wherein the one or more processors, to filter the list of possible vehicle options, are configured to:
remove at least one possible vehicle option, from the list, based on the at least one possible vehicle option being unavailable for the at least one destination location.

4. The system of claim 1, wherein the preference indicates:
whether the user prefers to drive or to ride; or
whether the user prefers price or convenience.

5. The system of claim 1, wherein the representation of the preferred vehicle option comprises a user interface including an interactive element.

6. The system of claim 5, wherein the confirmation comprises an indication of interaction with the interactive element.

7. The system of claim 1, wherein the first data source comprises a transaction processor or a travel system.

8. The system of claim 1, wherein the second data source comprises a calendar system.

9. A method of automatically connecting travel with vehicles, comprising:
receiving, from a first data source and at a connecting system, event information associated with a travel itinerary;
transmitting an authorization to access a second data source;
receiving, based on the authorization, based on a subscription to updates from the second data source, and at the connecting system, an indication of at least one destination location,
wherein the indication of at least one destination is received based on at least one of a schedule or updates to the second data source with new destination locations;
receiving, at the connecting system, a preference associated with a user;
providing, by the connecting system, the event information, the indication of the at least one destination location, and the preference to a machine learning model in order to receive an indication of a preferred vehicle option,
wherein a model parameter is used with the machine learning model,
wherein the model parameter includes an attribute of a model, associated with the machine learning model, that is learned from data input into the model,
wherein one or more hyperparameter sets are used to tune the machine learning model,
wherein the one or more hyperparameter sets include a structural parameter that controls execution of a machine learning algorithm, and
wherein the one or more hyperparameter sets are not learned from data input into the model;
outputting, from the connecting system, a representation of the preferred vehicle option to a user device associated with the user;
receiving, from the user device, at the connecting system, and in response to outputting the representation, a confirmation of the preferred vehicle option;
communicating, by the connecting system, with an application programming interface (API) function, by transmitting a request to the API function, wherein the request is in response to the confirmation and includes information related to the preferred vehicle option, to secure the preferred vehicle option;
communicating with an additional API function, in response to an error message from communicating with the API function to secure the preferred vehicle option, to secure a next preferred vehicle that is indicated by the machine learning model; and
transmitting instructions to the user device to generate user interface elements representing that the next preferred vehicle is secured.

10. The method of claim 9, further comprising:
transmitting, to the first data source, a request for the event information, the request including an authorization associated with the user,
wherein the event information is received in response to the request.

11. The method of claim 9, further comprising:
transmitting, to the second data source, a request for calendar information that indicates the at least one destination location, the request including a set of credentials associated with the user,
wherein the indication of the at least one destination location is received in response to the request.

12. The method of claim 9, further comprising:
receiving, from the user device and at the connecting system, a set of credentials associated with a service providing the preferred vehicle option,
wherein the set of credentials are used in communicating with the API function.

13. The method of claim 9, further comprising:
receiving, from the API function and at the connecting system, the error message;
outputting, from the connecting system and to the user device, an indication of the error message and of the next preferred vehicle option that was indicated by the machine learning model;
receiving, from the user device, an acceptance of the next preferred vehicle option; and
communicating, by the connecting system, with the additional API function, in response to the acceptance, to secure the next preferred vehicle option.

14. The method of claim 9, wherein providing the event information, the indication of the at least one destination location, and the preference to the machine learning model comprises:
transmitting, to a machine learning host, a request including the event information, the indication of the at least one destination location, and the preference; and
receiving, from the machine learning host and in response to the request, the indication of a preferred vehicle option.

15. A non-transitory computer-readable medium storing a set of instructions for automatically connecting travel with vehicles, the set of instructions comprising:
one or more instructions that, when executed by one or more processors of a device, cause the device to:
transmit, to a travel system, an authorization to access a calendar source associated with a user of the device;
transmit, to the travel system, a preference associated with the user of the device;
transmit an instruction to book a travel itinerary;
receive an indication of at least one destination location based on a subscription to updates from the calendar course,
wherein the indication of at least one destination is received based on at least one of a schedule or updates to the calendar source with new destination locations;
receive, from the travel system, based on using a machine learning model to analyze information associated with the preference, and based on the at least one destination, an indication of a preferred vehicle option,
wherein a model parameter is used with the machine learning model,
wherein the model parameter includes an attribute of a model, associated with the machine learning model, that is learned from data input into the model,
wherein one or more hyperparameter sets are used to tune the machine learning model,
wherein the one or more hyperparameter sets include a structural parameter that controls execution of a machine learning algorithm, and
wherein the one or more hyperparameter sets are not learned from data input into the model;
output a representation of the preferred vehicle option to the user;
receive, from the user, an interaction with the representation of the preferred vehicle option;
transmit, to the travel system, a confirmation of the preferred vehicle option in response to the interaction, to secure the preferred vehicle option via an application programming interface (API) function by transmitting a request to the API function,
wherein the request includes information related to the preferred vehicle option,
cause communication with an additional API function, in response to an error message from communicating with the API function to secure the preferred vehicle option, to secure a subsequent preferred vehicle that is indicated by the machine learning model; and
transmit instructions to a user device to generate user interface elements representing hat the subsequent preferred vehicle is secured.

16. The non-transitory computer-readable medium of claim 15, wherein the one or more instructions, when executed by the one or more processors, cause the device to:
determine the preference based on historical information associated with the user; and
store the preference for later retrieval.

17. The non-transitory computer-readable medium of claim 15, wherein the one or more instructions, when executed by the one or more processors, cause the device to:
receive, from the travel system, an indication that the preferred vehicle option is secured; and
output, to the user, a representation that the preferred vehicle option is secured.

18. (canceled)

19. The non-transitory computer-readable medium of claim 15, wherein the one or more instructions, when executed by the one or more processors, cause the device to:
transmit, to the travel system, an authorization to access transaction information associated with the user of the device.

20. The non-transitory computer-readable medium of claim 15, wherein the one or more instructions, when executed by the one or more processors, cause the device to:
receive, from the travel system, an indication of a first preferred vehicle option; and
transmit, to the travel system, a rejection of the first preferred vehicle option,
wherein the indication of the preferred vehicle option is received in response to the rejection.

21. The system of claim 1, wherein the one or more processors are configured to cause generation of interface elements that include:
a first interactive element that triggers a confirmation of a vehicle option;
a second interactive element that triggers transmitting a request to change the vehicle option; and
a third interactive element that triggers transmitting a rejection of the vehicle option;
wherein the subsequent preferred vehicle option is based on a response triggered by the at least one of the first interactive element, the second interactive element, and the third interactive element.
